(19) United States
(12) Patent Application Publication
(10) Pub. No.: US 2017/0302148 A1
(43) Pub. Date: Oct. 19, 2017

(54) SELF-POWERED GENERATOR

(71) Applicant: Robert Beckton, Hopkinsville, KY (US)

(72) Inventor: Robert Beckton, Hopkinsville, KY (US)

(21) Appl. No.: 15/098,086

(22) Filed: Apr. 13, 2016

(51) Int. Cl. H02K 47/20; H02K 7/10; H02K 47/04; H02K 53/00

(52) U.S. Cl. CPC H02K 47/20; H02K 47/04; H02K 7/1004; Y10S 74/09; H02K 53/00

(57) ABSTRACT

A self-powered generator disclosed here includes a stator member, a rotor member, a direct current motor, and an alternating current motor. The rotor member is configured to rotate within the stator member, and the direct current motor is coupled to a rotor shaft of the rotor member, where the direct current motor is configured to rotate the rotor member within the stator member via the rotor shaft to generate electricity. However, the direct current motor is shut off when a predetermined amount of electricity is generated, where a portion of the electricity generated is fed to an alternating current motor coupled to the rotor shaft, where the alternating current motor continuously drives the rotor member within the stator member in a closed loop arrangement to generate a continuous supply of electricity.

### BACKGROUND

Conventionally, there are different methods for power generation, for example, hydroelectric power, thermal power, nuclear power, solar power, etc. In each of power generation systems mentioned above, a certain source of energy is converted into electrical energy, such as, converting the potential and kinetic energy of a water in a dam in a hydroelectric power plant, converting the chemical energy of the coal or a similar flammable fuel in thermal power plants, converting the energy released by a radioactive material in a nuclear power plant, converting the light energy from the sun in solar power plant, etc. Since, each of these methods require devices which are expensive and involve a significant cost in installation and running, the cost of producing electricity per year increases in a drastic manner. In order to counter this problem, fuel powered generators were used which used a diesel powered engine to drive the generator to produce electricity.

However, in the case of diesel powered generators, the rise of fuel costs has raised problems for customers for choosing such kind of a fuel charged power generation systems. Further, the loud sound generated by the diesel powered generators has been a cause of bird deaths and causes a great deal of sound pollution. Pollution as a result of exhaust from the diesel engines is another issue which threatens the clean energy policy in various countries. Therefore, there is a need for a system or a method which will provide power generation from within itself, without the help of converting a certain form of available energy such as water or sunlight, where there is no need for any fossil fuel like gas or diesel.

Hence, there is a long felt but unresolved need for a self-powered generator which can generate electricity from itself without converting an available form of energy, where the power generation process avoids: high electricity bill expenses, bird deaths caused by loud sound of the conventional diesel engines, and expenses that would have been involved if conventional fossil fuels were used. The self-powered generator therefore avoids the need of propellers, solar power panels, and water flow.

### SUMMARY OF THE INVENTION

The self-powered generator as disclosed herein addresses the above mentioned needs to avoid: high electricity bill expenses, bird deaths caused by loud sound of the conventional engines, and expenses that would have been involved if conventional fossil fuels were used. The self-powered generator comprises a stator member, a rotor member, a direct current motor, and an alternating current motor. The rotor member is configured to rotate within the stator member, and the direct current motor is coupled to a rotor shaft of the rotor member, where the direct current motor is configured to rotate the rotor member within the stator member via the rotor shaft to generate electricity. However, the direct current motor is shut off when a predetermined amount of electricity is generated, where a portion of the electricity generated is fed to an alternating current motor coupled to the rotor shaft, where the alternating current motor continuously drives the rotor member within the stator member in a closed loop arrangement to generate a continuous supply of electricity.

In an embodiment, the self-powered generator further comprises a battery unit which is configured to power the direct current motor to drive the rotor member within the stator member. In an embodiment, the direct current motor and the alternating current motor are coupled to the rotor shaft via belt drives. In an embodiment, the self-powered generator further comprises a control panel configured to monitor the output values of current, voltage, and power generated. In an embodiment, the control panel further comprise gauges comprising a first gauge, a second gauge, and a third gauge. The first gauge is configured to display the amount of output current generated, the second gauge is configured to display the amount of output voltage generated, and the third gauge is configured to display the amount of output power generated. In an embodiment, the control panel further comprises a regulator switch configured to selectively start and stop the direct current motor and the alternating current motor.

### BRIEF DESCRIPTION OF THE DRAWINGS

FIG. 1 exemplarily illustrates a schematic view of the self-powered generator.

### DETAILED DESCRIPTION OF THE INVENTION

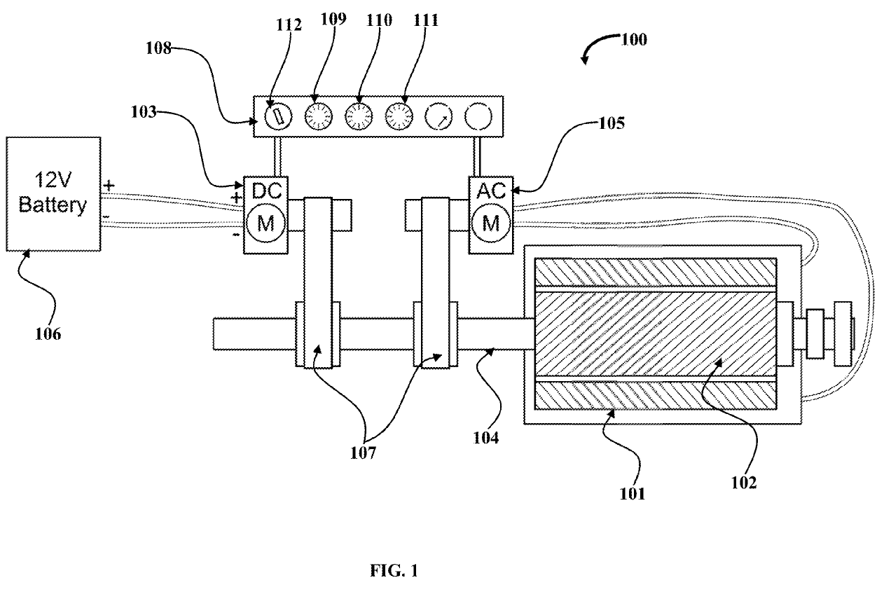

FIG. 1 exemplarily illustrates a schematic view of the self-powered generator 100. The self-powered generator 100 comprises a stator member 101, a rotor member 102, a direct current motor 103, and an alternating current motor 105. The rotor member 102 is configured to rotate within the stator member 101, and the direct current motor 103 is coupled to a rotor shaft 104 of the rotor member 102, where the direct current motor 103 is configured to rotate the rotor member 102 within the stator member 101 via the rotor shaft 104 to generate electricity. However, the direct current motor 103 is shut off when a predetermined amount of electricity is generated, where a portion of the electricity generated is fed to an alternating current motor 105 coupled to the rotor shaft 104, where the alternating current motor 105 continuously drives the rotor member 102 within the stator member 101 in a closed loop arrangement as shown in FIG. 1, to generate a continuous supply of electricity.

Here, the direct current motor 103 is only used as a startup motor to start the rotor shaft 104 of the rotor member 102 so that the rotor shaft 104 rotates at a predetermined rotations per minute (r.p.m), and thus, a predefined value of electricity is produced from the self-powered generator 100. After a predefined time period, a certain amount of electricity is produced by the self-powered generator 100 from which a portion is fed back to the alternating current motor 105 which is coupled to the rotor shaft 104, thereafter the alternating current motor 105 works in a closed loop where the portion of the generated electricity continuously drives the alternating current motor 105 to rotate the rotor member 102 so that a continuous and unlimited alternating current (A.C) power supply is produced from the self-powered generator 100.

In an embodiment, the self-powered generator 100 further comprises a battery unit 106 which is configured to power the direct current motor 103 to drive the rotor member 102 within the stator member 101. In an embodiment, the direct current motor 103 and the alternating current motor 105 are coupled to the rotor shaft 104 via belt drives 107. In an embodiment, the self-powered generator 100 further comprises a control panel 108 configured to monitor the output values of current, voltage, and power generated. In an embodiment, the control panel 108 further comprise gauges, for example, a first gauge 109, a second gauge 110, and a third gauge 111. The first gauge 109 is configured to display the amount of output current generated, the second gauge 110 is configured to display the amount of output voltage generated, and the third gauge 111 is configured to display the amount of output power generated. In an embodiment, the control panel 108 further comprises a regulator switch 112 configured to selectively start and stop the direct current motor 103 and the alternating current motor 105.

In a working example, a user first starts the direct current motor 103 coupled to the rotor shaft 104 which is powered by the battery unit 106, where the direct current motor 103 rotates the rotor shaft 104 and hence the rotor member 102. The rotation of the rotor member 102 within the stator member 101 generates an alternating current which is used to operate household electronic devices. After a certain amount of time the user checks the first gauge 109, the second gauge 110, and the third gauge 111 on the control panel 108 to analyze the values of output current, output voltage, and output power. When the electric power generated is of a forecasted value, the user shuts off the direct current motor 103 via the regulator switch 112 so that a portion of this alternating current generated is supplied to the alternating current motor 105 through a feedback arrangement as shown in FIG. 1, where the alternating current powers the alternating current motor 105 to drive the rotor member 102 within the stator member 101. Hence, an unlimited amount of power is generated from within the closed loop system defined by the alternating current motor 105, the rotor member 102, and the stator member 101. Therefore, the self-powered generator 100 provides clean energy which is free of sound pollution, free of fuel wastage and fuel expenses, and provides complete elimination of monthly electricity bills.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

I claim:

1. A self-powered generator, comprising:
a stator member;
a rotor member configured to rotate within the stator member;
a direct current motor coupled to a rotor shaft of the rotor member, wherein the direct current motor is configured to rotate the rotor member within the stator member via the rotor shaft to generate electricity, wherein the direct current motor is shut off when a predetermined amount of electricity is generated, wherein a portion of the electricity generated is fed to an alternating current motor coupled to the rotor shaft, wherein alternating current motor continuously drives the rotor member within the stator member in a closed loop arrangement to generate a continuous supply of electricity.

2. The self-powered generator of claim 1, further comprising a battery unit which is configured to power the direct current motor to drive the rotor member within the stator member.

3. The self-powered generator of claim 1, wherein the direct current motor and the alternating current motor are coupled to the rotor shaft via belt drives.

4. The self-powered generator of claim 1, further comprising a control panel configured to monitor the output values of current, voltage, and power generated.

5. The self-powered generator of claim 4, wherein the control panel further comprise gauges comprising:
a first gauge configured to display the amount of output current generated;
a second gauge configured to display the amount of output voltage generated; and
a third gauge configured to display the amount of output power generated.

6. The self-powered generator of claim 4, wherein the control panel further comprises a regulator switch configured to selectively start and stop the direct current motor and the alternating current motor.
